(19) United States
(12) Patent Application Publication
(10) Pub. No.: US 2008/0024665 A1
(43) Pub. Date: Jan. 31, 2008

(54) Information processing apparatus and information processing method

(75) Inventor: Sao Nakoji, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/878,575

(22) Filed: Jul. 25, 2007

(30) Foreign Application Priority Data
Jul. 27, 2006 (JP) 205276/2006

(51) Int. Cl. H04N 5/46

(52) U.S. Cl. 348/558; 348/E05.096

(57) ABSTRACT

In order to make it possible to precisely remove an adverse effect ascribable to degradation of compressed stream data in processing after the stream data has been decoded, a decoding portion obtains audio data by decoding an audio stream that is the compressed data, an error check portion makes an error check in a course of the decoding, a quality assessment portion assesses a quality of the audio data based on a result of the check by the error check portion, a control portion controls a noise reduction processing portion in accordance with the quality assessed by the quality assessment portion, and the noise reduction processing portion performs processing for reducing noise at the time of reproduction of the audio data in accordance with the control by the control portion.

### BACKGROUND OF THE INVENTION

1. Field of the Invention

The present invention relates to an information processing apparatus, and more particularly, to a technology for, when a digital broadcasting signal or the like is received, assessing quality of the signal.

2. Description of the Related Art

In digital audio broadcasting, a digital audio broadcasting (DAB) system in conformity with a European standard (Eureka 147) has been put to practical use.

In the DAB system, audio data is compressed in accordance with a compression system, such as MPEG audio, and is further modulated through orthogonal frequency division multiplexing (OFDM), thereby being converted into a broadcasting signal (hereinafter referred to as “DAB signal”). When generally referred to based on a digital broadcasting system, the former processing is information source coding (source coding), in which original information, such as characters, an image, or audio, is coded, and the latter processing is transmission path coding (channel coding) in which the information that has already undergone the information source coding is coded again in accordance with a property, such as a band, noise, or interference, of a transmission path through which the information is sent.

A DAB reception apparatus demodulates the DAB signal modulated in accordance with an OFDM system, performs decoding of the demodulated signal that is compressed data, and reproduces the audio data. When generally referred to in a like manner, the former processing is transmission path decoding (channel decoding) and the latter processing is information source decoding (source decoding). It should be noted that in the following description, unless otherwise specified, processing of the transmission path decoding is referred to as “demodulation” and processing of the information source decoding is referred to as “decoding”.

The OFDM is one kind of multicarrier modulation system and is considered that reception that is not influenced by multipath and fading and is therefore stabilized becomes possible in mobile communication with this technology. In reality, however, the data is degraded in the transmission path due to various reasons, which leads to a situation where the received data possesses certain digital errors. When the data containing the digital errors is reproduced, a degraded part becomes noise and gives an unpleasant feeling to a listener.

In JP 2002-300061 A, a technology for alleviating such an unpleasant feeling is disclosed. With this technology, at a digital audio broadcasting reception apparatus, at the time of demodulation of a received DAB signal, a bit error rate (BER) value is detected as an indicator indicating a degree of degradation of data. Then, processing is carried out in which output of decoding is halted or an output level, in other words, volume at the time of reproduction of audio data obtained as a result of the decoding is changed in accordance with the detected BER value, for instance.

With a technology disclosed in JP 2003-110439 A, at the time of Viterbi decoding of a received DAB signal, a digital error rate is detected. Then, when audio data obtained as a result of the decoding is reproduced afterward, in accordance with the detected digital error rate, control is performed so that, for instance, a lowpass filter is applied or the reproduction is halted, thereby alleviating discomfort given by a degraded part to a listener.

With the two technologies described above, however, a signal degradation state is detected at the time of the demodulation of the DAB signal, in other words, the degradation state detection is performed using the signal before the decoding. Therefore, it is difficult to precisely grasp which part of the audio data after the decoding is degraded in sound quality and to reliably control which part should be subjected to sound quality processing. Therefore, it is impossible to substantially alleviate the sound quality degradation, which leads to a problem in that an unpleasant feeling given by noise or the like to a user is not reduced.

This problem exists not only in the case of the DAB broadcasting reception apparatus but also in the case of a reception system for a packet containing an audio stream, examples of which are a digital video broadcasting (DVB) reception system and an advanced television systems committee (ATSC) reception system.

### SUMMARY

With a view to solving the above mentioned problem, an information processing apparatus according to an aspect of the present invention includes: a decoding portion for generating decoded data by decoding stream data that is compressed data and making an error check at the time of the decoding; and a quality assessment portion for assessing quality of the decoded data based on a result of the error check.

Further, an information processing apparatus according to another aspect of the present invention includes: a transmission path decoder for converting a received signal into an information source coded signal; an information source decoder for converting the information source coded signal into original information; and a quality assessment portion for assessing quality of the original information in accordance with a result of an error check obtained at the time of the conversion by the information source decoder.

The decoding portion or information source decoder described above is positioned immediately before a site at which decompression into the original information, such as characters, an image, or audio, is performed, so it becomes possible to identify a precise position of an error of the original information that should be subjected to error processing. It also becomes possible to satisfy a requirement that certain processing of the original information must be completed within a fixed period of time, in other words, a so-called real-time property is guaranteed.

It should be noted that a form, in which the apparatuses described above are replaced with methods, systems, or programs, is also effective as a mode of the present invention.

With the information processing apparatus according to the present invention, it becomes possible to reliably alleviate sound quality degradation ascribable to degradation of compressed stream data in processing after the stream data has been decoded, which makes it possible to reduce an unpleasant feeling given by noise or the like to a user.

### BRIEF DESCRIPTION OF THE DRAWINGS

FIG. 1 shows a configuration of a DVB broadcasting receiver according to a first embodiment;

FIG. 2 shows a configuration of an audio signal processing portion of the DVB broadcasting receiver shown in FIG. 1;

FIG. 3 shows a configuration of a noise reduction processing portion of the audio signal processing portion shown in FIG. 2;

FIG. 4 is a flowchart showing the outline of processing by the audio signal processing portion shown in FIG. 2;

FIG. 5 is a flowchart showing processing by a quality assessment portion of the audio signal processing portion shown in FIG. 2;

FIG. 6 is a flowchart showing processing by a control portion of the audio signal processing portion shown in FIG. 2;

FIG. 7 is a flowchart showing processing by the noise reduction processing portion of the audio signal processing portion shown in FIG. 2;

FIG. 8 shows a configuration of a receiver according to a second embodiment;

FIG. 9 shows a configuration of an audio signal processing portion of the receiver shown in FIG. 8; and

FIG. 10 is a flowchart showing processing that is performed by the audio signal processing portion shown in FIG. 9 and relates to control of synchronization processing.

### DETAILED DESCRIPTION OF THE PREFERRED EMBODIMENTS

Hereinafter, concrete embodiments, to which the present invention has been applied, will be described in detail with reference to the accompanying drawings. First, a first embodiment will be described.

In the first embodiment, the present invention is applied to a DVB broadcasting receiver and quality of audio data is assessed by making an error check at a time of decoding of a compressed audio stream. Then, noise reduction processing corresponding to a result of the quality assessment is performed on the audio data. In this manner, an unpleasant feeling resulting from degradation of the data in a transmission path and given to a listener is alleviated.

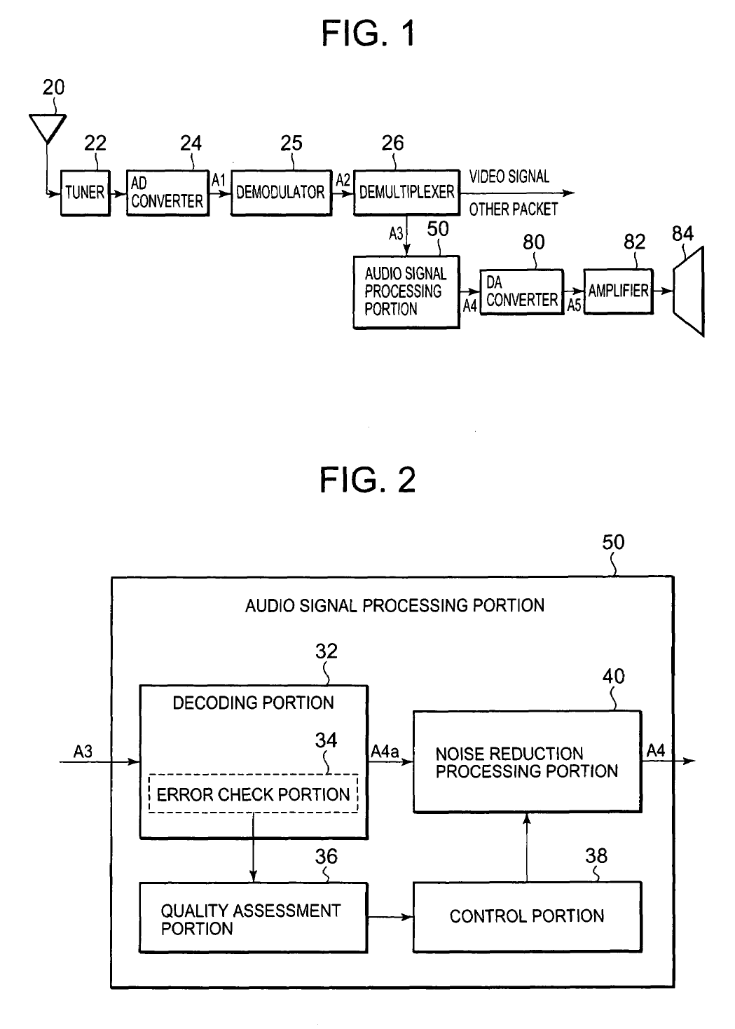

FIG. 1 shows a configuration of a DVB broadcasting receiver (herein after also referred to simply as “receiver”) 100 according to this embodiment. It should be noted that a DVB broadcasting signal contains both of a video signal and an audio signal, but the following description will be centered on processing of the audio signal, so only portions relating to the audio signal are shown in FIG. 1 and the illustration and description of a configuration for processing the video signal will be omitted.

As shown in FIG. 1, the receiver 100 includes an antenna 20, a tuner 22, an AD converter 24, a demodulation portion 25, a demultiplexer 26, an audio signal processing portion 50, a DA converter 80, an amplifier 82, and a speaker 84. The tuner 22 obtains a DVB broadcasting wave signal through the antenna 20. The AD converter 24 obtains a digital signal A1 by AD-converting the broadcasting wave signal obtained by the tuner 22 and the demodulation portion 25 obtains a TS packet (hereinafter referred to as “demodulation signal A2”) by performing demodulation processing including subcarrier demodulation, an error correction, and the like on the digital signal A1. The demultiplexer 26 demultiplexes the demodulation signal A2 into an audio signal A3, a video signal, and other packets. The audio signal A3 is a signal compressed using an audio compression system, such as an MPEG audio compression system or advanced audio coding (AAC), and will be hereinafter referred to as “audio stream A3”.

Audio data A4 is obtained from the audio stream A3 by the audio signal processing portion 50, which will be described in detail later. The DA converter 80 converts the audio data A4 into an analog audio signal A5. The amplifier 82 amplifies the analog audio signal A5 and the speaker 84 reproduces the amplified analog audio signal A5.

FIG. 2 shows a configuration of the audio signal processing portion 50 of the receiver 100 shown in FIG. 1. The audio signal processing portion 50 includes a decoding portion 32, a quality assessment portion 36, a control portion 38, and a noise reduction processing portion 40, with an error check portion 34 being provided for the decoding portion 32. It should be noted that each of elements illustrated in the drawing as functional blocks that perform various processing within the audio signal processing portion 50 is formed of a CPU, a memory, or another LSI chip in terms of hardware and is realized by a program loaded into a memory or the like in terms of software. Therefore, it is understood by persons skilled in the art that the functional block is realizable in various forms such as a form based on only hardware, a form based on only software, and a form based on a combination thereof, and the present invention is not limited to one form.

The decoding portion 32 obtains audio data A4a by decoding the audio stream A3 transmitted from the demultiplexer 26 and outputs the data A4a to the noise reduction processing portion 40.

The error check portion 34 provided for the decoding portion 32 makes an error check in course of the decoding by the decoding portion 32 and outputs a result of the check to the quality assessment portion 36. Here, the error check portion 34 checks an error relating to degradation of the audio data A4a. For instance, the error check portion 34 makes one of a syntax error check of a header portion in the audio stream A3, a CRC check, a threshold value check at a time when decoding corresponding to each encoding system, such as Huffman coding, is performed, a check of presence or absence of possibility of deviation from a correct decoding flow, and the like or performs a combination of some thereof. Ordinarily, the audio stream A3 is composed of multiple frames and the error check portion 34 obtains, for each frame, a result of the error check and outputs the check result to the quality assessment portion 36.

The quality assessment portion 36 assesses quality of a target frame based on the error check result outputted from the error check portion 34. Here, it is sufficient that the frame quality assessment is simply carried out using only the result of the error check made on the target frame, but for more precise assessment, the quality assessment portion 36 in this embodiment assesses the quality of the target frame by summarizing the result of the error check performed on the target frame and several (ten, for instance) frames immediately before the target frame in chronological order. It should be noted that in this case, the quality assessment portion 36 is provided with a memory (not shown) for storing the result of the error check performed on the frames before the target frame.

The control portion 38 performs control of the noise reduction processing portion 40 based on a result of the assessment by the quality assessment portion 36 and the noise reduction processing portion 40 performs noise reduction processing on the audio data A4a obtained by the decoding portion 32 in accordance with the control by the control portion 38. The noise reduction processing is processing for reducing an unpleasant feeling given by noise ascribable to degradation to a listener when the audio data A4a is reproduced afterward.

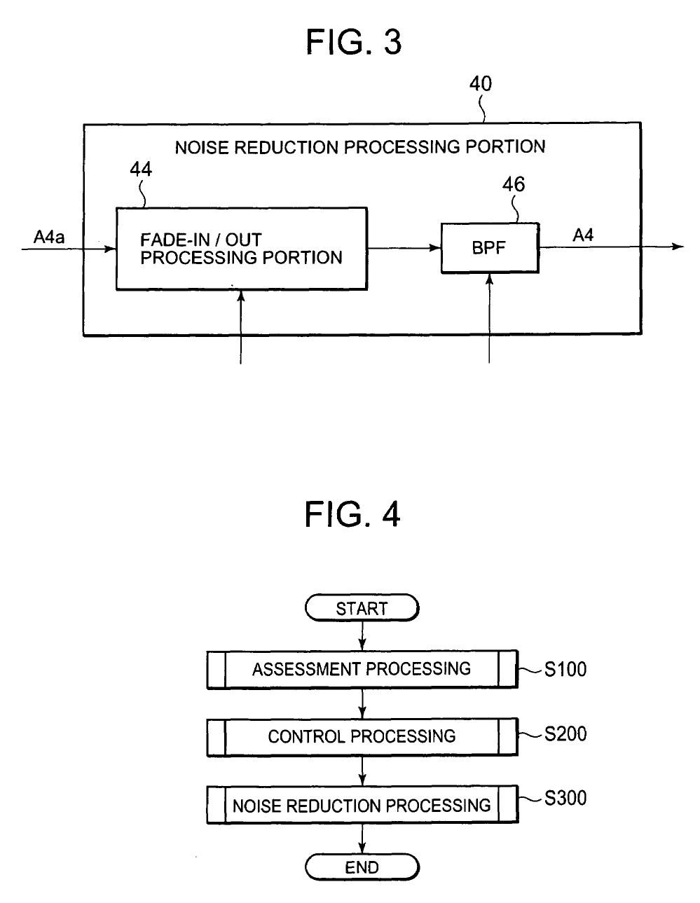

FIG. 3 shows a configuration of the noise reduction processing portion 40. In this embodiment, by way of example, the noise reduction processing portion 40 includes a fade-in/out processing portion 44 and a band-pass filter (hereinafter also referred to as “BPF”) 46, which are controlled by the control portion 38 in units of frames.

FIG. 4 is a flowchart showing a flow of processing by the quality assessment portion 36, the control portion 38, and the noise reduction processing portion 40. The quality assessment portion 36 performs assessment processing for assessing the quality of the audio data A4a (S100) and the control portion 38 performs control processing for the noise reduction processing portion 40 based on the result of the assessment by the quality assessment portion 36 (S200). The noise reduction processing portion 40 performs noise reduction processing of the audio data A4a in accordance with the control by the control portion 38 (S300). Hereinafter, details of each processing will be described.

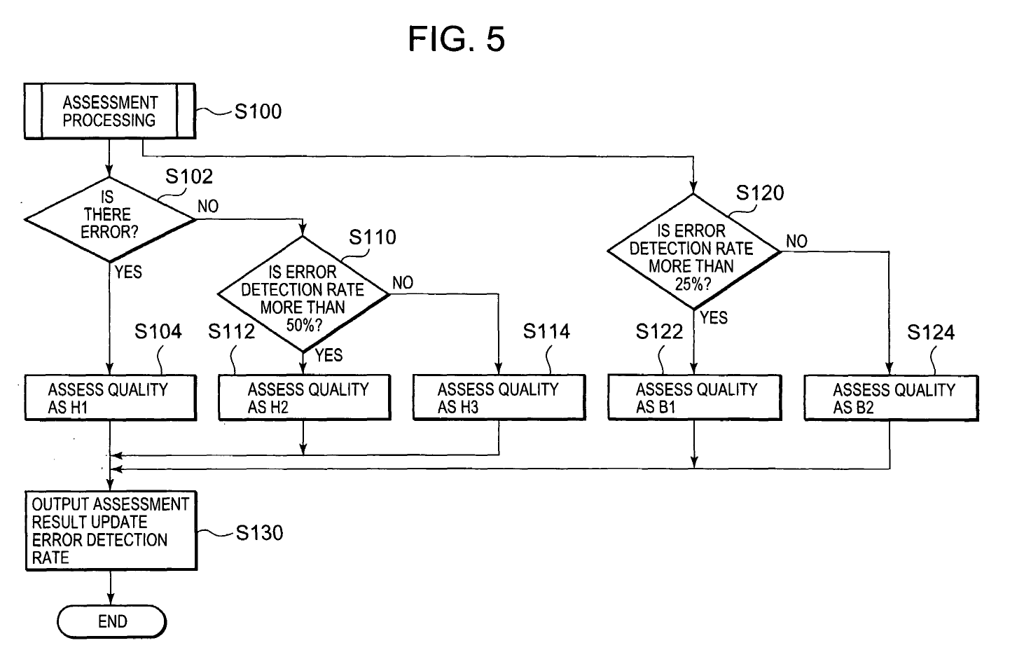

FIG. 5 is a flowchart showing the assessment processing by the quality assessment portion 36. In this embodiment, the noise reduction processing portion 40 performs the noise reduction processing by using two elements that are the fade-in/out processing portion 44 and the BPF 46, so the quality assessment portion 36 makes an assessment for control of each of the elements. Therefore, it becomes possible to make use of a characteristic of each of the fade-in/out processing portion 44 and the BPF 46 and perform finer control.

Steps S102 to S114 are assessment processing for control of the fade-in/out processing portion 44 and steps S120 to S124 are assessment processing for control of the BPF 46. Hereinafter, the former assessment processing will be referred to as “first assessment processing” and the latter assessment processing will be referred to as “second assessment processing”.

In the first assessment processing, the quality assessment portion 36 first judges whether the error check portion 34 has detected an error from a target frame (S102). When a result of the judgment is affirmative, the quality assessment portion 36 assesses quality of the frame as “quality H1” indicating that a degree of degradation is large (S102: Yes, S104). On the other hand, when the judgment result is negative, the quality assessment portion 36 further confirms an error detection coverage (number of frames in which errors have been detected/10) calculated from the result of the error check performed on the immediately preceding ten frames and saved in a memory (not shown) (S102: No, S110). When the error detection coverage is more than 50%, the quality assessment portion 36 assesses the quality as “quality H2” indicating that the degradation degree is middle in defiance of a fact that no error has been detected from the target frame (S110: Yes, S112). On the other hand, when the error detection coverage is equal to or less than 50%, the quality assessment portion 36 assesses the quality of the target frame as “quality H3” indicating that the degradation degree is small or there is no degradation (S110: No, S114).

The second assessment processing is carried out based on the error detection coverage. When the error detection coverage is more than 25%, the quality assessment portion 36 assesses the quality of the target frame as “quality B1” indicating that there is degradation (S120: Yes, S122). On the other hand, when the error detection coverage is equal to or less than 25%, the quality assessment portion 36 assesses the quality of the target frame as “quality B2” indicating that there is no degradation (S120: No, S124).

The quality assessment portion 36 outputs the results of the two assessments to the control portion 38. In addition, the quality assessment portion 36 calculates a new error detection coverage using the result of the error check performed on the target frame and the immediately preceding nine frames and updates the error detection coverage saved in the memory (S130).

Here, the first assessment processing of steps S102 to S114 and the second assessment processing of steps S120 to S124 are performed in parallel in this embodiment but they may be performed in succession.

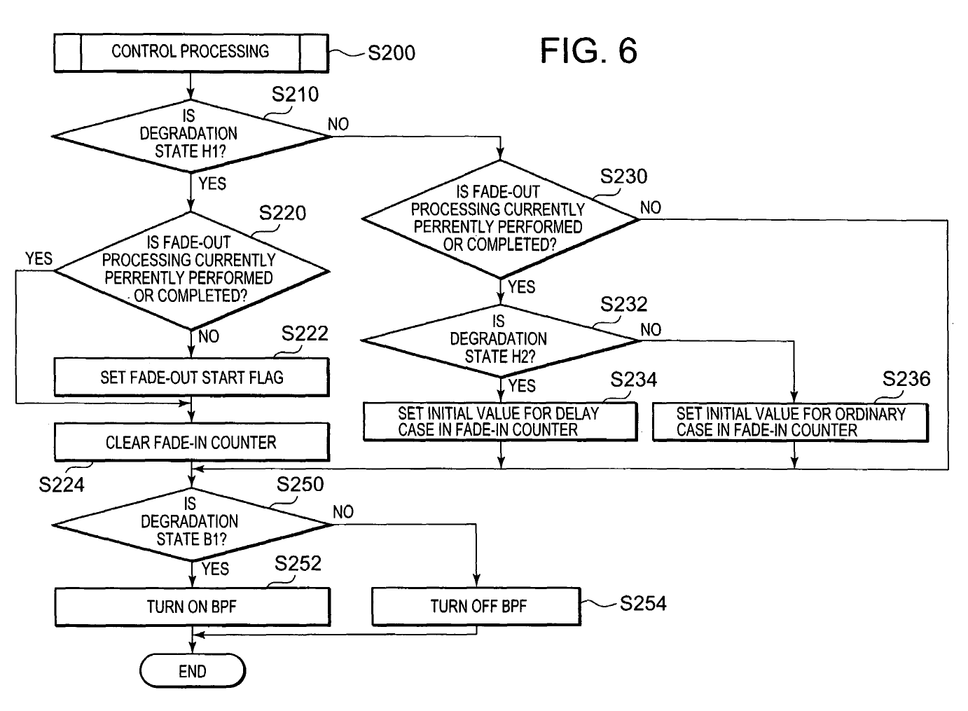

FIG. 6 is a flowchart showing the control processing by the control portion 38. The control portion 38 first controls the fade-in/out processing portion 44 in accordance with whether the quality is H1 (error has been detected in the target frame), H2 (error has not been detected in the target frame but the error detection coverage calculated from the immediately preceding ten frames is more than 50%), or H3 (error has not been detected in the target frame and the error detection coverage is equal to or less than 50%) (S210 to S236). More specifically, when the quality is H1 (S210: Yes), in a case where fade-out processing by the fade-in/out processing portion 44 is currently performed or is completed, the control portion 38 clears a fade-in counter (not shown) in order to cause the fade-in/out processing portion 44 to continue the fade-out processing and not to start fade-in processing (S220: Yes, S224). On the other hand, when the fade-out processing by the fade-in/out processing portion 44 is neither currently performed and nor completed, the control portion 38 sets a flag indicating immediate start of the fade-out processing and also clears the fade-in counter (S220: No, S222, S224). Here, the flag for the start of the fade-out processing exists in a main program loaded into a memory (not shown), for instance, and the control portion 38 is capable of controlling the fade-in/out processing portion 44 by setting and resetting the flag.

On the other hand, in a case where it is found in step S210 that no error has been detected from the target frame, when the fade-out processing by the fade-in/out processing portion 44 is currently performed or is completed and the quality is H2, the control portion 38 sets a value (initial value for delay) for delaying a reemission sound in the fade-in counter in order to delay a timing of the reemission sound (S230: Yes, S232: Yes, S234). Also, when the fade-out processing by the fade-in/out processing portion 44 is currently performed or is completed and the quality is H3, the control portion 38 sets an ordinary initial value (initial value for ordinary case) that is smaller than the initial value for delay in the fade-in counter in order to emit the reemission sound (S230: Yes, S232: No, S236). In another case (S210: No, S230: No), the control portion 38 does not perform the control for changing the processing by the fade-in/out processing portion 44.

Next, the control portion 38 controls the BPF 46 in accordance with whether the quality is B1 (error detection coverage is more than 25%) or B2 (error detection coverage is equal to or less than 25%) (S250 to S254). More specifically, when the quality is B1, the control portion 38 turns on the BPF 46 (S250: Yes, S252). On the other hand, when the quality is B2, the control portion 38 turns off the BPF 46 (S250: No, S254).

It should be noted that in the flowchart shown in FIG. 6, the control processing for the fade-in/out processing portion 44 and the control processing for the BPF 46 are performed in succession but they may be performed in parallel.

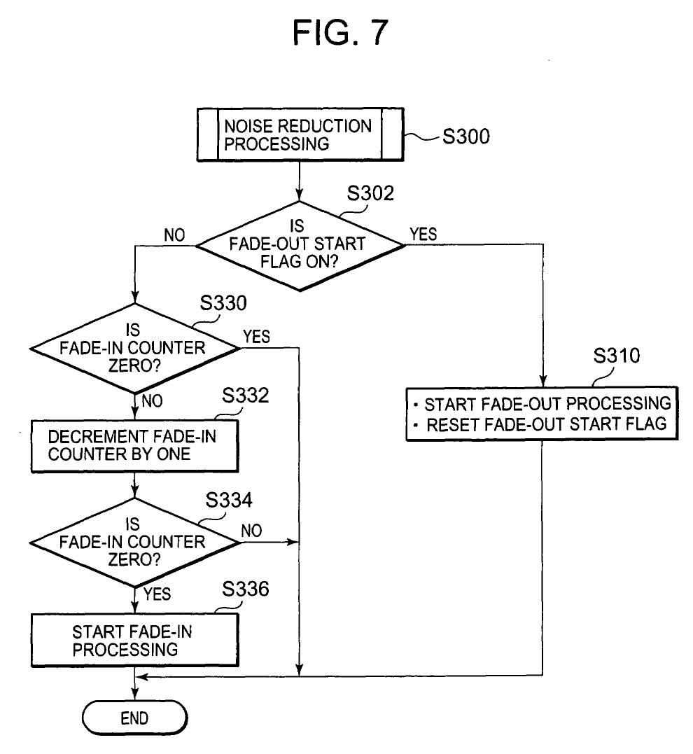

The noise reduction processing portion 40 is a portion for processing the audio data A4a in accordance with the control by the control portion 38 and the processing thereof is executed within an audio output interrupt handler, for instance. FIG. 7 is a flowchart showing a flow of the processing. It should be noted that the BPF 46 is merely turned on (filtering is performed) or turned off (filtering is not performed) in accordance with the control by the control portion 38, so in order to facilitate understanding, only the processing by the fade-in/out processing portion 44 is illustrated and will be described.

When the fade-out start flag is on (S302: Yes), the fade-in/out processing portion 44 starts the fade-out processing immediately and also resets the fade-out start flag in response to the start of the fade-out processing (S310).

On the other hand, when the fade-out start flag is off (S302: No), the fade-in/out processing portion 44 judges whether the value of the fade-in counter is “0”. Then, when a result of the judgment is affirmative, the fade-in/out processing portion 44 maintains a present state without performing fade-in processing (S330: Yes). On the other hand, when the judgment result is negative (S330: No), the fade-in/out processing portion 44 decrementes the fade-in counter by one. Then, when the fade-in counter becomes “0”, the fade-in/out processing portion 44 starts the fade-in processing (S332 to S336). In other words, when the initial value of the fade-in counter is set to the initial value for delay, a time until the start of the fade-in processing becomes long as compared with a case where the fade-in counter initial value is set to the initial value for ordinary case.

The audio data A4 obtained as a result of the noise reduction processing by the noise reduction processing portion 40 is subjected to DA conversion by the DA converter 80 and amplification processing by the amplifier 82, and is reproduced from the speaker 84.

In the manner described above, the receiver 100 in this embodiment assesses the quality of the audio stream data A4a using the result of the error check made on the audio stream A3 that is compressed stream data at the time of the decoding, so it becomes possible to grasp which part (frame, in this embodiment) of the audio data has been degraded. Therefore, it becomes possible to reliably perform processing for alleviating sound quality degradation on the degraded part.

Also, relating to the two technologies described in the “BACKGROUND OF THE INVENTION” section of this specification, in order to realize a technique with which noise is reduced by, for instance, changing an audio output level, an indicator of a degradation degree obtained at the time of carrier wave demodulation or demultiplexing is used at the time of noise reduction processing, so it is required that a demodulation portion and a demultiplexer preceding an audio signal processing portion and an amplifier and the like succeeding the audio signal processing portion are connected. Therefore, in a system in which a demultiplexer is not connected in a previous stage, it becomes impossible to perform noise reduction processing.

In contrast, the receiver 100 according to this embodiment assesses quality of audio data based on a result of an error check made at the time of decoding without depending on a result of an error check at the time of demodulation of a DVB signal, so it becomes possible to perform processing for reducing noise in the audio signal processing portion 50. Therefore, even when the amplifier and the demultiplexer are not connected, it becomes possible to reduce noise. Also, even when a general-purpose amplifier is used as the amplifier succeeding the audio signal processing portion 50, it becomes possible to provide the effect of reducing noise.

Further, in the receiver 100 according to this embodiment, the quality assessment portion 36 of the audio signal processing portion 50 uses not only the result of the error check performed on the target frame but also the result of the statistical treatment of the error check performed on the multiple frames immediately preceding the target frame in the quality assessment, so more precise assessment becomes possible and, by extension, it becomes possible to provide a more favorable noise reduction effect. For instance, even when no error has been detected from the target frame, through the statistical treatment of the result of the error check performed on the immediately preceding multiple frames, it becomes possible to predict occurrence of an error to some extent and noise reduction processing having a real-time property becomes possible.

Still further, the receiver 100 in this embodiment is a form, in which the present invention has been applied to a DVB broadcasting reception apparatus, but the present invention is not limited to the application to the DVB apparatus and is applicable also to a transmission and reception system for a packet containing an audio stream, such as an advanced television systems committee (ATSC) system, an integrated services digital broadcasting (ISDB) system, an Internet protocol television (IPTV) system involving a network, or a digital audio broadcasting (DAB) system.

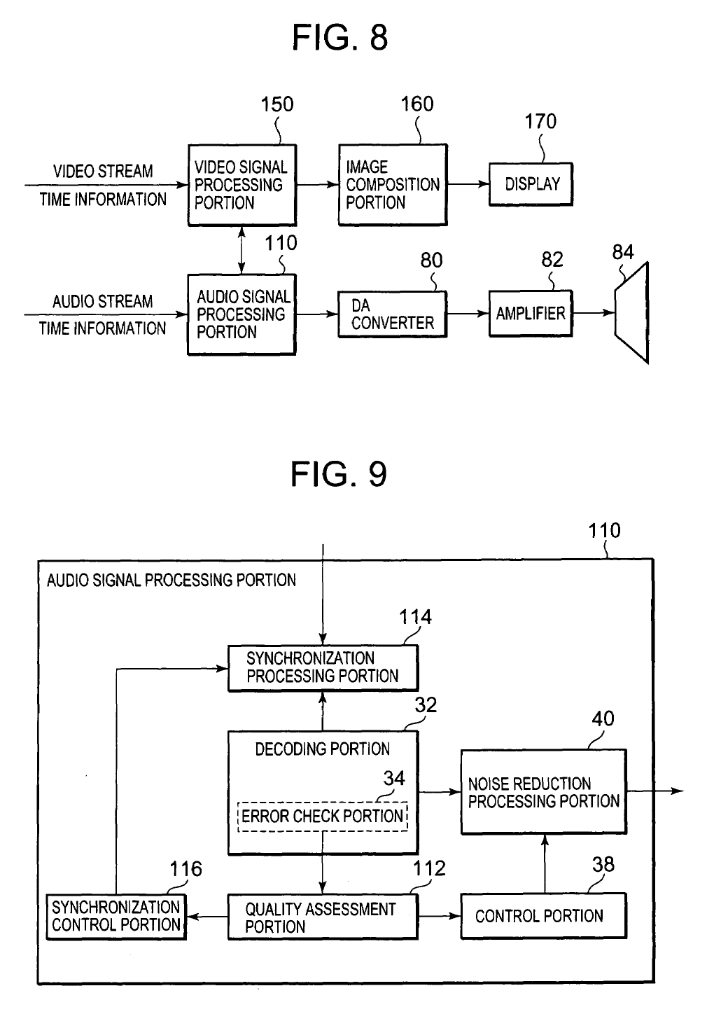

FIG. 8 shows a configuration of a DVB receiver (hereinafter referred to simply as “receiver”) that focuses attention on relationship between an audio stream and a video stream. The receiver 200 receives a video signal as well as an audio signal and performs decoding processing. Like in the case of the receiver 100, for the audio signal, the receiver 200 makes an error check on compressed audio stream at the time of decoding and assesses quality of audio data based on a result of the error check. Then, the receiver 200 performs noise reduction processing corresponding to a result of the quality assessment on the audio data and also controls processing for synchronization with the video signal. This embodiment will be described by omitting configuration elements such as an antenna, a tuner, a demodulation portion, and a demultiplexer.

As shown in FIG. 8, the receiver 200 includes a video signal processing portion 150, an image composition portion 160, and a display 170 as configuration elements for processing the video signal and includes an audio signal processing portion 110, a DA converter 80, an amplifier 82, and a speaker 84 as configuration elements for processing the audio signal. The DA converter 80, the amplifier 82, and the speaker 84 are the same components provided for the receiver 100 and therefore are given the same reference numerals and will not be described in this embodiment.

A demodulated video stream is video data compressed with an image compression system, such as MPEG, and is inputted into the video signal processing portion 150 together with time information. The video signal processing portion 150 obtains video data by decoding the video stream and outputs the video data to the image composition portion 160. The image composition portion 160 composes the video data from the video signal processing portion 150 into an image for display output and outputs the image to the display 170. The display 170 displays the image outputted from the image composition portion 160.

On the other hand, a demodulated audio stream is inputted into the audio signal processing portion 110 together with time information. The audio signal processing portion 110 obtains audio data by decoding the audio stream and outputs the audio data to the DA converter 80. FIG. 9 shows a configuration of the audio signal processing portion 110.

As shown in FIG. 9, the audio signal processing portion 110 includes a decoding portion 32, a quality assessment portion 112, a control portion 38, a noise reduction processing portion 40, a synchronization processing portion 114, and a synchronization control portion 116. The decoding portion 32, the control portion 38, and the noise reduction processing portion 40 are the same as those provided for the receiver 100 and therefore will not be described in this embodiment.

The synchronization processing portion 114 communicates with the video signal processing portion 150 and performs synchronization processing for establishing synchronization between the output of the video signal and the output of the audio signal, based on the time information inputted into the audio signal processing portion 110 and the time information inputted into the video signal processing portion 150.

The synchronization control portion 116 controls the synchronization processing portion 114 to halt the synchronization processing when quality of the audio data is equal to or less than a predetermined degree. Also, during the halt, when the quality of the audio stream has recovered and a predetermined recovery condition has been satisfied, the synchronization control portion 116 controls the synchronization processing portion 114 to resume the synchronization processing.

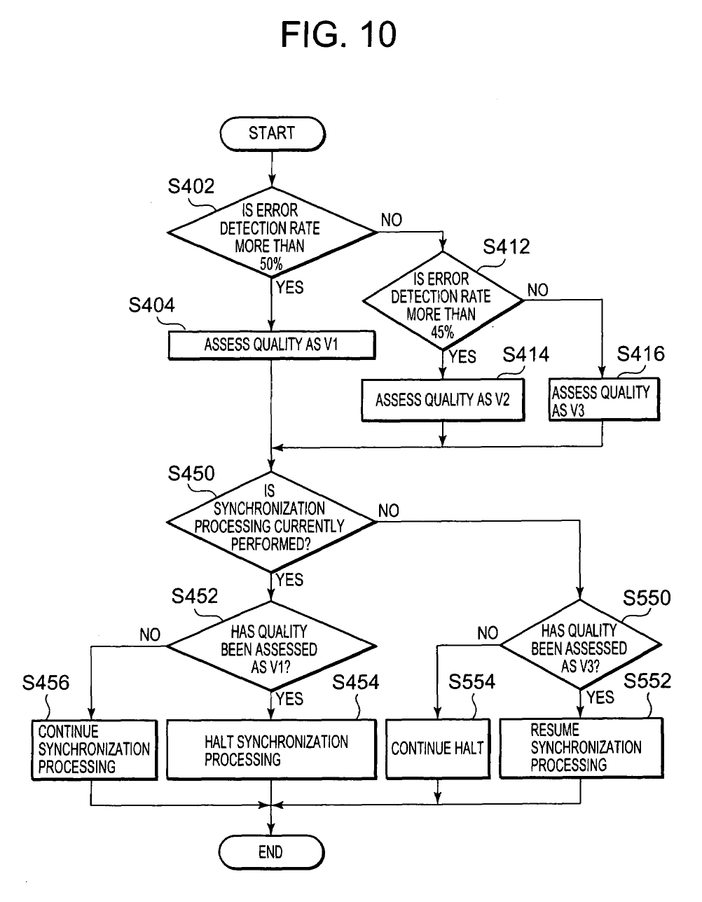

In addition to the assessment processing performed by the quality assessment portion 36 of the receiver 100, the quality assessment portion 112 also performs assessment processing for allowing the synchronization control portion 116 to perform the control of the synchronization processing. Here, the processing by the quality assessment portion 112 and the synchronization processing portion 114 in the control of the synchronization processing will be described with reference to a flowchart shown in FIG. 10.

In the flowchart shown in FIG. 10, steps S402 to S416 are the assessment processing performed by the quality assessment portion 112 for the control of the synchronization processing and steps S450 to S554 are the control processing performed by the synchronization control portion 116. The quality assessment portion 112 confirms an error detection coverage calculated from ten frames immediately before a target frame. Following the calculation, when the error detection coverage is more than 50%, the quality assessment portion 112 assesses the quality of the audio data as “quality V1” indicating that degradation of the audio data is significant and the synchronization processing should be halted (S402: Yes, S404). Also, when the error detection coverage is equal to or less than 50% and equal to or more than 45%, the quality assessment portion 112 assesses the audio data quality as “quality V2” indicating that the degradation of the audio data exerts an influence on the synchronization processing but a degree thereof is not so significant as in the case of the quality V1 (S402: No, S412: Yes, S414). Further, when the error detection coverage is less than 45%, the quality assessment portion 112 assesses the audio data quality as “quality V3” indicating that approximately no adverse effect is exerted (S402: No, S412: No, S416).

The synchronization control portion 116 performs the control of the synchronization processing in accordance with a result of the assessment by the quality assessment portion 112. During the synchronization processing, when the quality of the audio data has been assessed as “V1”, the synchronization control portion 116 halts the synchronization processing (S450: Yes, S452: Yes, S454). On the other hand, during the halt of the synchronization processing, when the quality of the audio data has been assessed as “V3”, the synchronization control portion 116 resumes the synchronization processing (S450: No, S550: Yes). Also, in a case of other quality, the synchronization control portion 116 continues the synchronization processing when the synchronization processing is currently performed (S450: Yes, S452: No, S456) and maintains a halt state when the synchronization processing is currently halted (S450: No, S550: No, S554).

Degradation of stream data exerts a direct adverse effect when the stream data is used. In addition, in a system in which when two stream data that is separately processed is outputted, it is required to establish synchronization like in this embodiment, there is also possibility that degradation of one of the two stream data will hinder synchronization processing and make output of both of the data unstable. In such a system, when quality of audio data is assessed at the time of decoding like in the case of the audio signal processing portion 110, it becomes possible to precisely grasp a site of occurrence of the degradation, which enables control of the synchronization processing.

Also, the control of the synchronization processing is performed based on an error detection ratio calculated from multiple frames immediately before a target frame, so there is predictivity and it becomes possible to halt the synchronization processing before the system becomes unstable. As a result, even when there is degradation in the audio stream, it becomes possible to minimize an adverse effect thereof.

Further, by continuing the quality assessment even during the synchronization processing and resuming the synchronization processing when the quality has recovered until a predetermined condition is satisfied, it becomes possible to prevent the influence at the time of the degradation from continuing.

Still further, it is possible for the audio signal processing portion 110 to perform such control by itself and addition of another module is not required.

The present invention has been described above based on the embodiments. The embodiments are merely examples and it is possible to make various changes, addition, and omission within the gist of the present invention. It is understood by persons skilled in the art that modifications, in which such changes, addition, and omission have been made, are also included in the scope of the present invention.

For instance, at the time of the quality assessment, the audio signal processing portion 50 of the receiver 100 makes the quality assessment separately for the fade-in/out processing portion 44 and the BPF 46, thereby achieving finer noise reduction processing but when multiple apparatuses that perform the noise reduction processing with different techniques are included in the noise reduction processing portion 40, the same quality assessment may be carried out.

Also, the configuration of the noise reduction processing portion 40 is not limited to that of the receiver 100 described as an example and addition and omission may be made. For instance, only the fade-in/out processing portion 44 may be provided, only the BPF 46 may be used, or a module or an apparatus for volume adjustment (including mute processing) may be additionally provided.

Further, the number of frames, each threshold value, and the like used when the error detection coverage is obtained are not limited to those used as an example in the explanation of the embodiments described above and may be changed from system to system.

Still further, the audio signal processing portion 110 of the receiver 200 controls the synchronization processing in accordance with the quality of the audio data but may cause the video signal processing portion 150 to perform quality assessment processing having the same mechanism and control the synchronization processing in accordance with quality of video data or a combination of the quality of the audio data and the quality of the video data.

Needless to say, the control of the synchronization processing may be performed by the video signal processing portion 150.

Also, in each of the receiver 100 and the receiver 200, the quality assessment is made by the quality assessment portion and the control portion exerts the control by receiving the result of the assessment, but the quality assessment portion and the control portion may be integrated with each other and perform direct control based on the result of the check by the error check portion. In this case, the result of the quality assessment is not outputted as a signal but a combination of, for instance, “no error has been detected in the target frame” and “the error detection coverage is more than 50%” substantially becomes the assessment result.

Also, in the embodiments described above, the present invention is applied to the audio stream and the quality of the audio stream data is assessed using the result of the error check made at the time of the decoding of the audio stream, but the present invention is not limited to the application to the audio stream and is applicable also to a signal, such as the video stream, which is transmitted in a compressed form.

It is apparent that the present invention is not limited to the above embodiments, but may be modified and changed without departing from the scope and spirit of the invention.

What is claimed is:

1. An information processing apparatus, comprising:
a decoding portion decoding stream data to generate decoded data;
said decoding portion performing an error check while decoding the stream data; and
a quality assessment portion assessing a quality of the decoded data based on a result of the error check.

2. The information processing apparatus according to claim 1, further comprising:
a noise reduction processing portion performing a noise reduction at the time of reproducing the decoded data; and
a control portion controlling the noise reduction processing portion in accordance with said quality of the decoded data.

3. The information processing apparatus according to claim 1,
wherein said quality assessment portion performs statistical treatment on the result of the error check in a predetermined period of time and assesses the quality based on a result of the statistical treatment.

4. The information processing apparatus according to claim 1,
wherein said decoded data includes a plurality of frames, and
said quality assessment portion assesses the quality of a target frame based on an error detection coverage obtained from a plurality of frames immediately before the target frame.

5. The information processing apparatus according to claim 1, further comprising:
a synchronization processing portion establishing synchronization between the decoded data and other data; and
a synchronization processing control portion controlling the synchronization processing portion,
wherein the synchronization processing control portion brings synchronization processing to a halt when the quality is equal to or less than a predetermined level.

6. The information processing apparatus according to claim 5,
wherein the synchronization processing control portion resumes the synchronization processing when the quality has recovered to a predetermined degree during the halt of the synchronization processing.

7. An information processing method, comprising:
decoding stream data to generate decoded data;
performing an error check while decoding the steam data; and
assessing a quality of the decoded data based on a result of the error check.

8. The information processing method according to claim 7, further comprising:
performing noise reduction at the time of reproducing the decoded data in accordance with the assessed quality.

9. An information processing apparatus comprising:
a transmission path decoder converting a received signal into an information source coded signal;
an information source decoder converting the information source coded signal into original information; and
a quality assessment portion assessing a quality of the original information in accordance with a result of an error check obtained at the time of converting the information source decoder.

10. The information processing apparatus according to claim 9,
wherein the quality assessment portion assesses the quality based on a result of statistical treatment cumulatively performed on the result of the error check in a predetermined period of time.

11. The information processing apparatus according to claim 9,
wherein the original information is composed in units of frames, and
the quality assessment portion assesses the quality of a target frame based on the result of the error check obtained from a plurality of frames immediately before the target frame.

12. the information processing apparatus according to claim 9, further comprising:
a noise reduction processing portion performing a noise reduction at the time of reproducing the original information obtained from the information source decoder; and
a control portion controlling the noise reduction processing portion in accordance with the quality of the original information.

13. The information processing apparatus according to claim 9, further comprising:
a synchronization processing portion establishing synchronization between the original information and other original information; and
a synchronization processing control portion controlling the synchronization processing portion,
wherein the synchronization processing control portion brings synchronization processing to a halt when the quality is equal to or less than a predetermined level.

14. The information processing apparatus according to claim 13,
wherein the synchronization processing control portion resumes the synchronization processing when the quality has recovered to a predetermined degree during the halt of the synchronization processing.
